(19) United States
(12) Patent Application Publication
(10) Pub. No.: US 2021/0324906 A1
(43) Pub. Date: Oct. 21, 2021

(54) STUDDED BALL JOINT

(71) Applicant: MF IP Holding, LLC, West Jordan, UT (US)

(72) Inventor: Casey Heit, West Jordan, UT (US)

(73) Assignee: MF IP Holding, LLC, West Jordan, UT (US)

(21) Appl. No.: 16/851,708

(22) Filed: Apr. 17, 2020

(51) Int. Cl. F16C 11/08; F16C 11/06

(52) U.S. Cl. CPC F16C 11/08; F16C 11/0647

(57) ABSTRACT

A studded ball joint has a housing defining an interior cavity. A slot is formed at a first end of the housing and defines first and second guide surfaces. The interior cavity includes a concave surface. The studded ball joint further includes an annular sleeve slidingly engaged with the slot. A ball stud includes a bearing portion disposed within the cavity and sized to be at least partially received by the concave surface. The ball stud further includes an elongate stud portion extending from the bearing portion through the annular sleeve to define a first axis.

### BACKGROUND

Studded ball joints are commonly used in vehicles to connect upper and lower control arms the steering knuckle. Studded ball joints are also used in vehicle steering systems to connect tie rods to the steering knuckles. The 3-axis articulation, i.e., rotation, provided by studded ball joints allows for wheel alignment, i.e. adjustments to castor, camber, and toe, to be performed without imparting excessive loads that would be created by fixed axis joints.

In the case of tie rods, articulation around all 3 axes is not required and can result in undesirable performance characteristics. Specifically, the unrestrained articulation about all 3 axes allows the tie rod to wobble (rock back and forth) during vehicle operation, which can be noisy. Further, engagement of the studs with the housing at the limits of articulation results in concentrated loads that increase wear, thereby decreasing the useful life of the studded ball joints.

### SUMMARY

A first representative embodiment of a studded ball joint according to aspects of the present disclosure includes a housing defining an interior cavity. A slot is formed at a first end of the housing and defines first and second guide surfaces. The interior cavity includes a concave surface. The studded ball joint further includes an annular sleeve slidingly engaged with the slot. A ball stud includes a bearing portion disposed within the cavity and sized to be at least partially received by the concave surface. The ball stud further includes an elongate stud portion extending from the bearing portion through the annular sleeve to define a first axis.

In some embodiments, the ball stud is rotatable about the first axis relative to the annular sleeve.

In some embodiments, the annular sleeve includes first and second flat bearing surfaces on an exterior surface of the sleeve.

In some embodiments, the first and second flat bearing surfaces slidably engage the first and second guide surfaces, respectively, to prevent rotation of the annular sleeve about the first axis.

In some embodiments, the ball stud further defines a second axis perpendicular to the first axis, the second axis being parallel to the first guide surface and passing through a center of the spherical portion, wherein engagement of the annular sleeve with the first and guide surfaces prevents rotation of the bearing stud about the second axis.

In some embodiments, the ball stud further defines a third axis perpendicular to the first and second axes and passing through the center of the spherical portion, wherein the bearing stud is rotatable about the third axis.

In some embodiments, the annular sleeve slidingly engages the slot as the bearing stud rotates about the third axis.

In some embodiments, rotation of the bearing stud is limited by contact between the annular sleeve and first and second ends of the slot.

In some embodiments, the bearing stud is rotatable about the third axis through a range of 10° to 60°.

In some embodiments, the annular sleeve includes first and second flat bearing surfaces engaging the first and second guide surfaces.

A second representative embodiment of a studded ball joint according to aspects of the present disclosure includes a housing that defines a spherical interior cavity and has a slot formed at a first end. The sides of the slot define first and second guide surfaces. The studded ball joint include a ball stud with a spherical bearing portion and an elongate stud portion. The spherical bearing portion is disposed within the cavity. The elongate stud portion extends from the spherical bearing portion through the slot. The studded ball joint further includes an annular sleeve surrounding the elongate stud portion and slidingly engaging the slot.

In some embodiments, the annular sleeve includes a spherical surface disposed within the spherical interior cavity of the housing and a cylindrical portion extending through the slot.

In some embodiments, the cylindrical portion includes parallel flat surfaces slidingly engaging the first and second guide surfaces of the slot.

In some embodiments, the housing has a socket disposed within a cylindrical body, the socket and the cylindrical body cooperating to define the spherical interior cavity.

In some embodiments, the studded ball joint further includes a wear plate positioned on a concave recess of the socket.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a top isometric view of a represent embodiment of a studded ball joint according to the present disclosure;

FIG. 2 is a bottom isometric view thereof;

FIG. 3 is an exploded view thereof;

FIG. 4 is a top plan view thereof;

FIG. 5 is a cross-sectional view thereof as indicated in FIG. 4; and

FIG. 6 is a cross-sectional view thereof as indicated in FIG. 4.

### DETAILED DESCRIPTION

A studded ball joint is provided in which a ball stud restrained from translation relative to a housing in all directions. The ball stud is unrestrained against rotation relative to the housing about a first axis, has limited rotation relative to the housing about a second axis, and is restrained against rotation relative to the housing about a third axis.

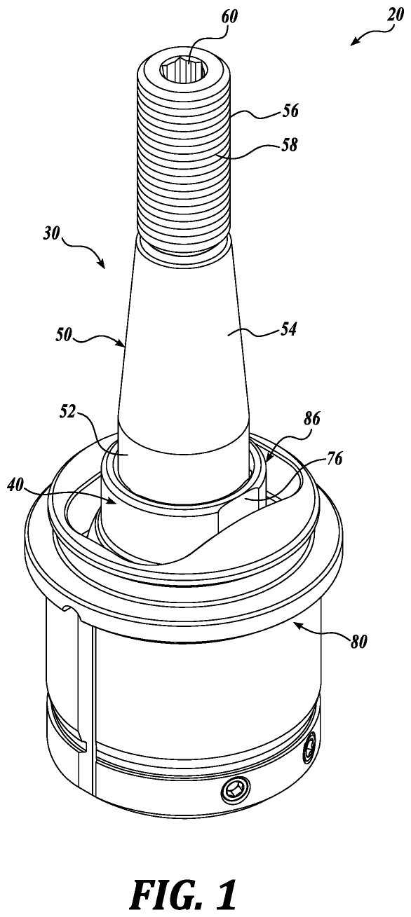

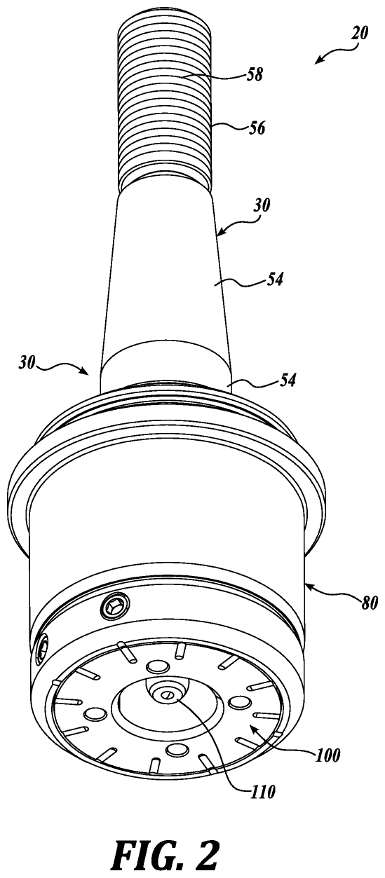

Referring to FIGS. 1 and 2, a representative embodiment of a studded ball joint 20 is shown. The studded ball joint 20 includes a bearing stud 30 partially disposed within a housing 80. More specifically, the bearing stud 30 includes a bearing portion 40 disposed within the housing 80 and an elongate stud portion 50 extending from the bearing portion through a slot 86 formed in the housing. A sleeve 70 surrounds the stud portion 50 of the bearing stud 30 proximate to the slot 86. As will be explained in further detail, the sleeve 70 engages the walls of the slot 86 to limit rotation of the bearing stud 30 relative to the housing 80.

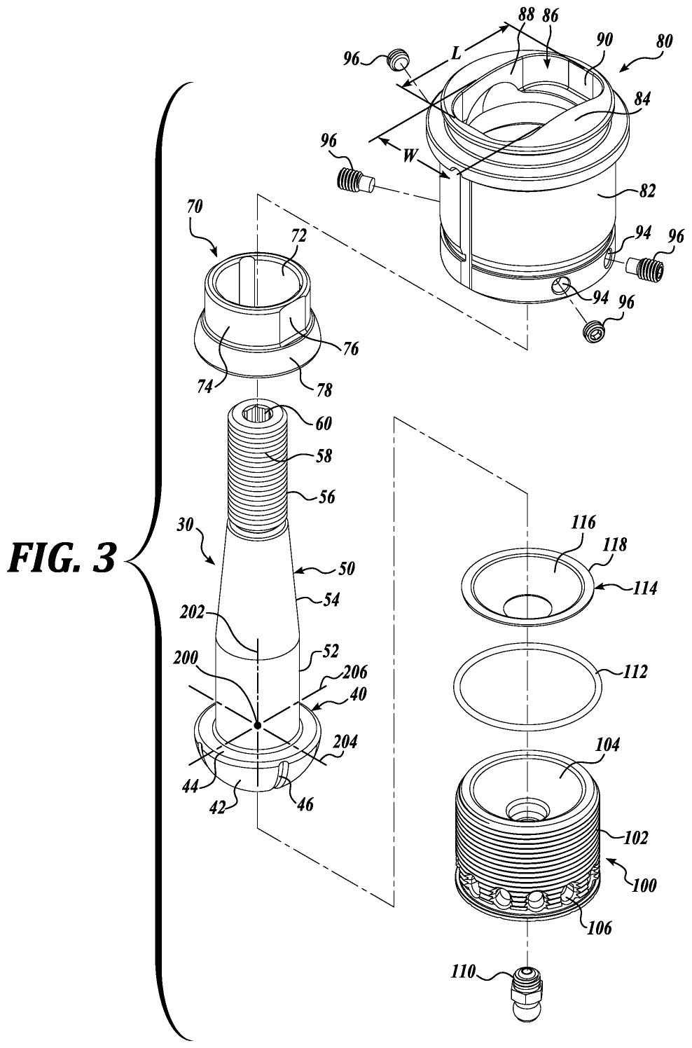

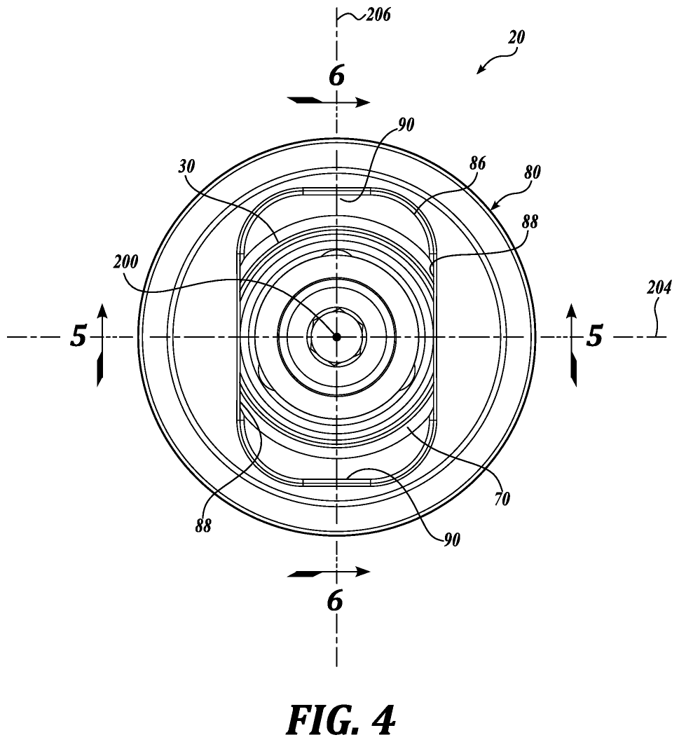

As best shown in FIGS. 3-6, the bearing portion 40 of the bearing stud 30 has the general shape of a spherical cap, i.e., a sphere truncated by a plane. In this regard, the bearing portion 40 includes a spherical surface 42 and a flat surface 44. It will be understood that the term “spherical surface” as used herein does not require that the surface define a complete sphere, but can instead define only a part of a sphere. The spherical surface 42 has a center point 200 that is the center of rotation for the bearing stud 30 and thus, the studded ball joint 20.

In some embodiments, lubrication paths 46 are optionally formed along the spherical surface 42 of the bearing portion 40. The lubrication paths 46 allow for distribution of lubricant, such as grease, along the spherical surface when the studded ball joint 20 is assembled. In the illustrated embodiment, the lubrication paths 46 take the form of recesses formed circumferentially along the spherical surface. It will be appreciated the illustrated lubrication paths are exemplary only, and the lubrication paths can take any suitable configuration. In some embodiments, lubrication paths 46 are also or alternatively formed in the housing 80. In other embodiments, the bearing stud 30 is a dry bearing.

The stud portion 50 of the bearing stud 30 extends in a perpendicular direction from the flat surface 40 of the bearing portion 40. In the illustrated embodiment, the stud portion 50 includes a cylindrical portion 52 proximate to the bearing portion 40 and a frustoconical portion 54 extending coaxially from the cylindrical portion. The frustoconical portion 54 tapers from a first diameter proximate to the cylindrical portion 52 to a second, smaller diameter distal to the cylindrical portion. A threaded portion 56 extends coaxially from the distal end of the frustoconical portion 54. The threaded portion 56 is a cylindrical element with external threads 58 formed thereon and an optional keyed feature 60 formed in the end of the threaded portion.

In the illustrated embodiment, the elongate portion 50 is generally configured in the manner of tie rod end. The frustoconical portion 54 is sized and configured to be received in a tapered hole in a steering knuckle and secured in place with a nut engaging the threads 58 of the threaded position. The keyed feature 60 in the illustrated embodiment is sized to receive hex key that prevents the bearing stud 30 from rotating while the bolt is secured to the threaded portion 56. It will be appreciated that the illustrated keyed feature 60 is exemplary only, and the keyed feature can optionally be configured to receive a torx head wrench, a screwdriver, or any other retaining tool. Further, the keyed feature 60 can be an external featured, such as a hexagonal feature configured to be received within a wrench or other suitable tool.

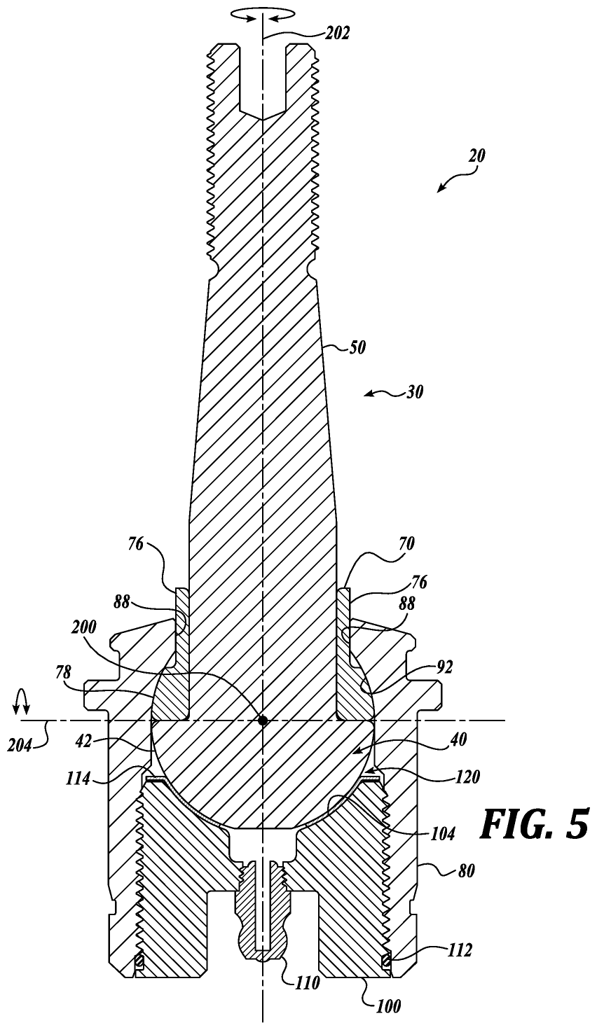

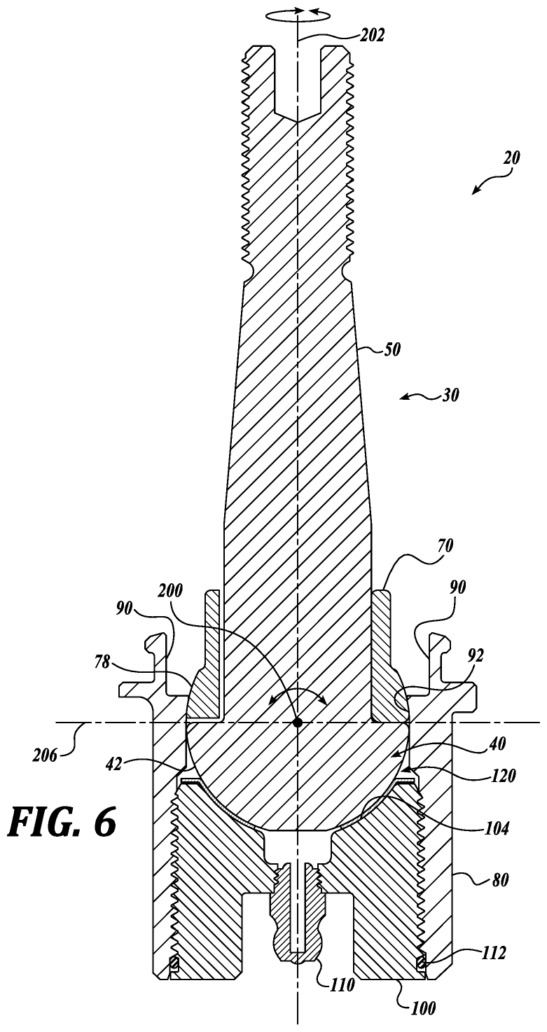

Still referring to FIGS. 3-6, the housing 80 includes a cylindrical body 82 that is open at a first end and is partially covered at a second end by a closeout 84. An elongate slot 86 is formed through the closeout 84. The slot 86 has a width W defined by parallel flat surfaces 88 and a length L defined by parallel surfaces 90. In the illustrated embodiment, the surfaces 90 are flat. In other embodiments, the surfaces are curved. As best shown in FIGS. 5 and 6, the interior side of the closeout 84 defines a spherical surface 92 having a radius that corresponds to the radius of the previously described spherical surface 42 of the bearing portion 40 of the bearing stud 30.

In the illustrated embodiment, the housing 80 is configured to be inserted into a cylindrical aperture of a component, such as a tie rod. The housing 80 can be secured to the component by a press fit, mechanical fastening, welding, or any other suitable configuration or combination of configurations. In some embodiments, one or more of the housing elements are integrally formed with the component to which the studded ball joint 20 is to be attached. It will be appreciated that the disclosed housing configuration is exemplary only, and alternate embodiments that accommodate different attachment configurations to various types of components are contemplated.

Referring again to FIGS. 3-6, a socket 100 has a cylindrical body 102 sized to be received within the open end of the housing 80. The socket 100 is secured to the housing 80 by a plurality of fasteners 96 that engage holes 106 formed in the cylindrical body 102 and corresponding holes 94 in the housing. A lubrication fitting 110 is mounted within a recess formed in the bottom of the socket 100 and is in fluid communication with the interior of the housing. An O-ring 112 seals the engagement of the housing 80 to the socket 100.

A spherical recess 104 is formed in the top of the cylindrical body 102. Like the spherical surface 92 on the interior of the closeout 84, the spherical recess 104 of the socket 100 has a radius that corresponds to the radius of the previously described spherical surface 42 of the bearing portion 40 of the bearing stud 30. As best shown in FIGS. 5 and 6, when the socket 100 is mounted within the housing 80, the housing and the socket cooperate to form an interior cavity 120. The spherical surface 92 on the interior of the closeout 84 and the spherical recess 104 of the socket 100 give the interior cavity 120 a generally spherical shape that is sized to receive the bearing portion 40 of the bearing stud 30.

A wear plate 114 is sized and configured to be received within the spherical recess 104 of the socket 100. The wear plate 114 includes a concave spherical portion 116 and a flat portion 118 extending radially from the edge of the spherical portion. The spherical portion 116 of the wear plate 114 is seated within the spherical recess 104 of the socket 100, and the flat portion 118 engages the socket 100 around the perimeter of the recess to maintain the orientation of the wear plate relative to the socket.

A sleeve 70 includes a central aperture 72 sized to receive the cylindrical portion 52 of the bearing stud 30. An upper portion of the sleeve 70 has a cylindrical surface 74. Parallel flat surfaces 76 are formed on opposite sides of the cylindrical surface 74. The flat surfaces 76 are spaced to be disposed between the surfaces 88 of the slot 86. A lower portion of the sleeve 70 has a spherical surface 78 with a radius corresponding to the radius of the spherical surface 92 on the interior of the closeout 84.

As shown in FIGS. 5 and 6, with the stud portion 50 of the bearing stud 30 extending through the sleeve 70, the spherical surface 42 of the bearing portion 40 of the bearing stud 30 and the cylindrical surface 78 of the sleeve have a common center 200 and a common radius. As a result, the spherical surfaces 42 and 78 cooperate to act as a single spherical surface. Referring specifically to FIG. 5, the spherical surface 92 of the housing 80 and the spherical surface 104 of the socket 100 (or more specifically, of the wear plate 114) also have a common center 200 and a common radius that corresponds to the radius of spherical surfaces 42 and 78.

Referring now to FIGS. 3, 5, and 6, the studded ball joint 20 has a coordinate system with an origin at the center point 200. A first axis 202 is coincident with the centerline of the stud portion 50 of the bearing stud 30. A second axis 204 is perpendicular to the first axis 202 and is parallel to the direction of the length L of the slot 86. A third axis 206 is perpendicular to the first axis 202 and the second axis 204, i.e., parallel to the direction of the width W of the slot 86.

The disclosed configuration prevents translation of the bearing stud 30 relative to the housing 80 in all directions as the housing 80 and socket 100 cooperate to restrain the bearing portion 40 and sleeve 70 from moving along the first, second, and third axes 202, 204, and 206.

The bearing stud 30 is rotatable about axis 202 relative to the sleeve 70. The sleeve 70 is in turn rotatably fixed about axis 202 relative to the housing 80 due to the engagement of the flat surfaces 76 on the sides of the sleeve 70 with the flat surfaces 88 extending along the lengthwise edges of the slot 86. Thus, the bearing stud 30 is rotatable about axis 202 relative to the housing 80.

With respect to axis 204, the bearing stud 30 is rotatably relative to the housing 80; however, the sweep of the bearing stud is limited by the sleeve 70 and the ends of the slot 86. As the bearing stud 30 rotates about axis 204, the sleeve 70 slides along the slot 86 until the sleeve contacts the end of the slot. Engagement of the sleeve 70 with the end of the slot 86 prevents further rotation of the bearing stud 30 about axis 204 in the direct of that end of the slot. In this manner, the articulation of the bearing stud 30 about axis 204, i.e., the articulation of the ball stud, is determined by the geometry of the sleeve 70 and the slot 86. Thus, the total articulation of the ball stud is the rotation of the bearing stud about axis 204 from (1) a position in which the sleeve 70 contacts one end of the slot 86 to (2) a position in which the sleeve contacts the other end of the slot. In some embodiments, the total articulation of the bearing stud 30 about axis 204 is about 35°. In some embodiments the articulation of the bearing stud 30 about axis 204 is in the range of 10° to 60°. The articulation may be symmetric with respect to a neutral position, i.e., +/−X° or asymmetric, wherein the bearing stud articulates further in one direction than the other. It will be appreciated that a required total articulation and the symmetry of articulation for a particular application can be provided by varying the geometry of the sleeve 70 and the slot 86.

Rotation of the bearing stud 30 with respect to the housing 80 about axis 206 is prevented by the engagement of the flat surfaces 76 on the sides of the sleeve 70 with the flat surfaces 88 extending along the length of the slot 86. While the engagement of the sleeve with the slot effectively prevents rotation of the bearing stud 30 relative to the housing 80 about axis 206, it will be appreciated that some small gaps will exist between the sleeve 70 and the slot 86 to account for manufacturing tolerances and to prevent binding. Accordingly, some small degree of rotation about axis 206 in the range of up to 3° is possible, and rotation is considered effectively prevented within this range.

When used with a typical tie rod, the disclosed studded ball joint 20 provides the same functionality as a typical tie rod end joint except that the studded ball joint eliminates one rotational degree of freedom. This limited motion prevents the tie rod from wobbling and making noise during vehicle operation. In addition, the engagement of the flat 76 surfaces of the sleeve 70 with the large, flat contact surfaces 88 of the slot distributes loads from the bearing stud 30 to the housing 80 more effectively to reduce bearing wear.

In the illustrated embodiment, the bearing stud 30, housing 80, and sleeve 70 are preferably made from hardened steel; however, it will be appreciated that other materials having suitable strength, durability, and fatigue characteristics may also be utilized and such variations should be considered within the scope of the present disclosure. The wear plate 114 is preferably made from a material, such as tool steel, that provides a suitable wear surface with reduced friction. In this regard, embodiments are contemplated using any material having a combination of suitable strength, durability, and fatigue characteristics in combination with a suitable coefficient of friction.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

In the foregoing description, specific details are set forth to provide a thorough understanding of exemplary embodiments of the present disclosure. It will be apparent to one skilled in the art, however, that the embodiments disclosed herein may be practiced without embodying all of the specific details. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A studded ball joint, comprising
a housing defining an interior cavity and having a slot formed at a first end, sides of the slot defining first and second guide surfaces, the interior cavity comprising a concave surface;
an annular sleeve slidingly engaged with the slot; and
a ball stud, comprising:
a bearing portion disposed within the cavity; and
an elongate stud portion extending from the bearing portion through the annular sleeve and defining a first axis.

2. The studded ball joint of claim 1, wherein the ball stud is rotatable about the first axis relative to the annular sleeve.

3. The studded ball joint of claim 1, the annular sleeve comprising first and second flat bearing surfaces on an exterior surface of the sleeve.

4. The studded ball joint of claim 3, wherein the first and second flat bearing surfaces slidably engage the first and second guide surfaces, respectively, to prevent rotation of the annular sleeve about the first axis.

5. The studded ball joint of claim 1, the ball stud further defining a second axis perpendicular to the first axis, the second axis being parallel to the first guide surface and passing through a center of the spherical portion, wherein engagement of the annular sleeve with the first and guide surfaces prevents rotation of the bearing stud about the second axis.

6. The studded ball joint of claim 5, the ball stud further defining a third axis perpendicular to the first and second axes and passing through the center of the spherical portion, wherein the bearing stud is rotatable about the third axis.

7. The studded ball joint of claim 6, the annular sleeve slidingly engaging the slot as the bearing stud rotates about the third axis.

8. The studded ball joint of claim 6, wherein rotation of the bearing stud is limited by contact between the annular sleeve and first and second ends of the slot.

9. The studded ball joint of claim 6, wherein the bearing stud is rotatable about the third axis through a range of 10° to 60°.

10. The studded ball joint of claim 1, the annular sleeve comprising first and second flat bearing surfaces engaging the first and second guide surfaces.

11. A studded ball joint, comprising:
a housing defining a spherical interior cavity and having a slot formed at a first end, sides of the slot defining first and second guide surfaces;
a ball stud, comprising:
a spherical bearing portion disposed within the cavity; and
an elongate stud portion extending from the spherical bearing portion through the slot; and
an annular sleeve surrounding the elongate stud portion and slidingly engaging the slot.

12. The studded ball joint of claim 11, the annular sleeve comprising a spherical surface disposed within the spherical interior cavity of the housing and a cylindrical portion extending through the slot.

13. The studded ball joint of claim 11, the cylindrical portion comprising parallel flat surfaces slidingly engaging the first and second guide surfaces of the slot.

14. The studded ball joint of claim 11, the housing comprising a socket disposed within a cylindrical body, the socket and the cylindrical body cooperating to define the spherical interior cavity.

15. The studded ball joint of claim 14, further comprising a wear plate positioned on a concave recess of the socket.
